(19) United States
(12) Patent Application Publication
(10) Pub. No.: US 2009/0212789 A1
(43) Pub. Date: Aug. 27, 2009

(54) MODIFIED TDR METHOD AND APPARATUS FOR SUSPENDED SOLID CONCENTRATION MEASUREMENT

(76) Inventors: Chih-Ping LIN, Jhubei City (TW); Chih-Chung Chung, Taipei City (TW)

Correspondence Address: SINORICA, LLC, 2275 Research Blvd., Suite 500, ROCKVILLE, MD, 20850, US

(21) Appl. No.: 12/117,773

(22) Filed: May 9, 2008

(30) Foreign Application Priority Data
Feb. 27, 2008 (TW) 097106785

(51) Int. Cl. G01N 22/00; G01K 13/02

(52) U.S. Cl. 324/642; 374/142; 374/E13.006

(57) ABSTRACT

This invention utilizes the principle of time domain reflectometry (TDR) to develop an improved apparatus and method for suspended solid concentration (SSC) measurement. The apparatus comprises a TDR sensing waveguide for stably determining an electromagnetic-wave (EM-wave) travel time and a temperature sensor. The TDR sensing waveguide and the temperature sensor are submerged in a suspension to detect the EM-wave travel time and the temperature. A temperature-corrected relationship between EM-wave travel time and SSC is found and used to estimate the SSC. Although TDR has been used for measuring soil moisture content and high SSC, its accuracy is not satisfactory for typical SSC monitoring. The present invention improves the accuracy of TDR in SSC measurement by providing the apparatus and method disclosed herein, which are not affected by an electrical conductivity of the suspension and particle sizes of suspended solids therein, and therefore meet the requirements of general engineering applications and environmental monitoring.

### BACKGROUND OF THE INVENTION

1. Technical Field

The present invention relates to a method and an apparatus for measuring the mixing ratio of a solid/liquid mixture and, more particularly, to a method and an apparatus for measuring the suspended solid concentration (SSC) of a suspension using time domain reflectometry (TDR).

2. Description of Related Art

Conventionally, the mixing proportion of a solid substance in a liquid can be determined by directly taking samples for measurement or by using existing automated measuring methods, such as optical, sonic, and newly-developed TDR methods, each implemented with a pertinent apparatus. Of all these methods, direct sampling for measurement is the most straightforward, wherein samples are taken manually or with a pump and then weighed and dried for further tests. Nevertheless, direct sampling incurs a high cost in time and manpower. Samples may also be disturbed and therefore lose their local representativeness. In addition, as it is difficult to take samples in rivers or reservoirs during flood periods, real-time testing results are not available so that the results cannot effectively reflect in situ conditions during such periods.

Commercial automated measuring methods for SSC monitoring are generally categorized into three types: optical, sonic wave-based and laser-based. However, the instrumental measurements carried out by these methods are easily affected by particle sizes of suspended solids or are limited to a narrow range of measurement. Therefore, these methods are not suitable for an environment where particle sizes change with time and SSC values varies in a wide range, such as the rivers and reservoirs in areas with erosion problems. Moreover, while the major time points for monitoring SSC values in river are during floods, the sophisticated instruments used in the automated methods are easily damaged during such periods by the speedy flows and the rocks and debris entrained thereby. And what is worse, the main components of existing instruments for automated measurement are for being submerged in water and therefore hard to maintain. Still further, the instruments are often too expensive to also deal with wide spatial coverage.

In TDR, a time domain reflectometer transmits an electromagnetic wave and records a reflected wavefrom from a TDR sensing waveguide, and various waveguides can be designed according to the principle of TDR to monitor different physical quantities, such as soil moisture content (based on dielectric permittivity), electrical conductivity, water level, and displacement. Similar to the measurement of soil moisture content, TDR can be used to measure the electrical conductivity and dielectric permittivity of a suspension and thereby estimate the SSC thereof, wherein the electric conductivity is in proportion to the SSC while the dielectric permittivity is in inverse proportion. When using TDR, a plurality of spots can be monitored by a single time domain reflectometer. Besides, the TDR sensing waveguide is easy to maintain and replace, and a higher range of concentrations can be measured with TDR. However, measurement via electrical conductivity tends to be affected by water salinity and particle sizes of suspended solids, and measurement via dielectric permittivity—though much less affected by water salinity and particle sizes of suspended solids—is not precise enough to meet the requirements of general SSC measurement.

In summary, direct sampling and existing automated measuring methods fail to handle simultaneously the accuracy, range, temporal and spatial resolution of SSC measurement and the maintainability of equipment. TDR, on the other hand, is a relatively new monitoring technique based on transmission lines, possessing several unique features unfound in other monitoring techniques. It can be used to measure electrical properties of a suspension and thereby estimate the SSC thereof while dealing with the aforesaid issues such as the range of measurement, temporal resolution, spatial resolution and maintainability of equipment at the same time. However, the accuracy of TDR in SSC measurement still does not meet the requirements of general engineering applications.

In view of the above, the present invention aims to develop a TDR-based method to improve the shortcomings of the prior methods and apparatuses for SSC measurement.

### SUMMARY OF THE INVENTION

To solve the aforementioned problems, the present invention provides a modified method and an apparatus for measuring the SSC of a suspension using TDR.

Currently, there are no effective measuring techniques for automatic SSC measurement, particularly in fluvial environment. Existing methods provide an accuracy much influenced by particle sizes of suspended solids, function only in a limited range of measurement and are not cost effective for field maintenance and wide spatial coverage. The present invention employs the principle of TDR to develop an improved apparatus and a method for SSC measurement. The apparatus comprises a TDR sensing waveguide for stably determining an EM-wave travel time and a temperature sensor. The method comprises steps of measuring a two-way travel time of an EM wave along the TDR sensing waveguide in a suspension and a temperature, and using a predetermined temperature-corrected relationship between EM-wave travel time and SSC to estimate the SSC of the suspension. TDR is a monitoring technique based on transmission lines, wherein a time domain reflectometer transmits an EM wave and receives a reflected EM wave, and wherein various TDR sensing waveguides can be designed according to the principle of TDR to monitor different physical quantities, such as soil moisture content, electrical conductivity, water level, displacement, and herein SSC. Unlike other techniques having a transducer with a built-in electronic sensor, TDR sensing waveguide is a simple mechanical device without any electronic components, and can be altered in dimension and accuracy according to the measuring environment. When connected to a TDR pulser above water for measurement, the submerged TDR sensing waveguide is rugged and can be economically replaced when damaged. Multiple TDR sensing waveguides can be connected to a TDR pulser through a multiplexer and automated, hence increasing both the temporal and spatial resolution. In addition to a low maintenance cost, the resulting monitoring also has a self-diagnosis function because a reflected waveform can be used to check the condition of the entire wiring for monitoring. In light of several advantages of TDR monitoring technique, the present invention is directed to developing a TDR-based apparatus and a data analysis method for monitoring suspended solid concentrations.

There is a linear relationship between the volumetric concentration of suspended solids in a suspension and the bulk dielectric permittivity of the suspension, wherein the bulk dielectric permittivity of the suspension can be determined by using TDR to measure a travel time of an EM wave along a TDR sensing waveguide (or “TDR travel time” for short). Although the linear relationship is influenced by temperatures and mineral compositions of the suspended solids, the temperature effect can be compensated via sensing the temperature while impacts from the mineral compositions are small. Samples may also be taken from the suspended solids to establish a calibrated relationship between SSC and TDR travel time beforehand.

By improving the TDR sensing waveguide and the data analysis method, the present invention enhances the stability of travel time measurement of a TDR reflected waveform along the TDR sensing waveguide, so that the travel time can be determined to the accuracy of one half of the instrumental sampling interval (i.e. timing resolution) and is independent of water salinity and particle sizes of suspended solids. More particularly, if a common time domain reflectometer for measuring soil moisture content is used, the accuracy of SSC measurement can reach 0.04% m³m⁻³. Better accuracy can be obtained by decreasing the instrumental sampling interval.

SSC measurement based on the principle of TDR preserves the features of TDR such as multiplexing (i.e., a plurality of spots can be monitored using one single time domain reflectometer), remote automation, low maintenance cost, and can be further combined with other TDR techniques for measuring water level, water depth, soil moisture content, etc. to form an integrated hydrological monitoring.

Therefore, the primary object of the present invention is to provide a method and an apparatus for measuring SSC of a suspension using TDR, wherein the method has a significantly increased accuracy in SSC measurement, compared with the related soil moisture content measurement, and is not affected by the electrical conductivity of the suspension and particle sizes of suspended solids in the suspension, so as to meet the requirements of general engineering applications and environmental monitoring.

The second object of the present invention is to provide the above-mentioned apparatus for measuring SSC, wherein a TDR sensing waveguide disposed at a front end thereof can be easily designed and manufactured as needed according to the measuring environment, and measurement can be conducted as soon as appropriate calibration is completed.

The third object of the present invention is to provide the above-mentioned apparatus for measuring SSC, wherein a TDR pulser is placed above water surface and the TDR sensing waveguide at the front end of the apparatus is in water. The TDR sensing waveguide comprises no electronic components and will not be easily damaged. Even if the event that the sensing device at the front end of the apparatus is damaged, it is inexpensive and can be replaced individually, thereby lowering maintenance cost of the entire monitoring. In addition, the monitoring provides a self-diagnosis function in which a reflected waveform can be used to check the condition of the entire wiring for monitoring.

The fourth object of the present invention is to provide the above-mentioned apparatus for measuring SSC, which integrates various hydrological monitoring functions of TDR, such as monitoring water level, water depth, soil moisture content, etc., therein so as to form an integrated TDR hydrological monitoring. The integrated monitoring can monitor a plurality of spots using a multiplexer, perform multiple monitoring functions, and allow remote automation.

### BRIEF DESCRIPTION OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is a schematic drawing of an SSC measuring apparatus according to a preferred embodiment of the present invention;

FIG. 2 is a schematic drawing of a TDR sensing waveguide according to the preferred embodiment of the present invention;

FIGS. 3A and 3B illustrate a reflected waveform and associated EM-wave travel time in the TDR sensing waveguide according to the preferred embodiment of the present invention;

FIG. 4 is a flow chart of a typical calibrating and measuring process according to the preferred embodiment of the present invention; and

FIG. 5 illustrates a calibrated relationship between TDR travel time and SSC according to the preferred embodiment of the present invention.

### DETAILED DESCRIPTION OF THE PREFERRED EMBODIMENT

The present invention discloses a method and an apparatus for SSC measurement using TDR. Since definitions of EM waves, waveguides, SSC and other related terms as well as manufacturing and processing procedures thereof could be found in and implemented with prior art, a detailed description thereof will be omitted herein. Besides, the appended drawings are intended only to demonstrate schematically features of the present invention and are therefore not, and are unnecessary to, drawn according to actual dimensions.

In the method and apparatus of the present invention for measuring the SSC of a suspension using TDR, the method comprises steps of measuring a two-way travel time of an EM wave (or “TDR travel time” for short) along a TDR sensing waveguide in the suspension and a temperature, and using a predetermined temperature-corrected relationship between TDR travel time and SSC to analyze the SSC of the suspension.

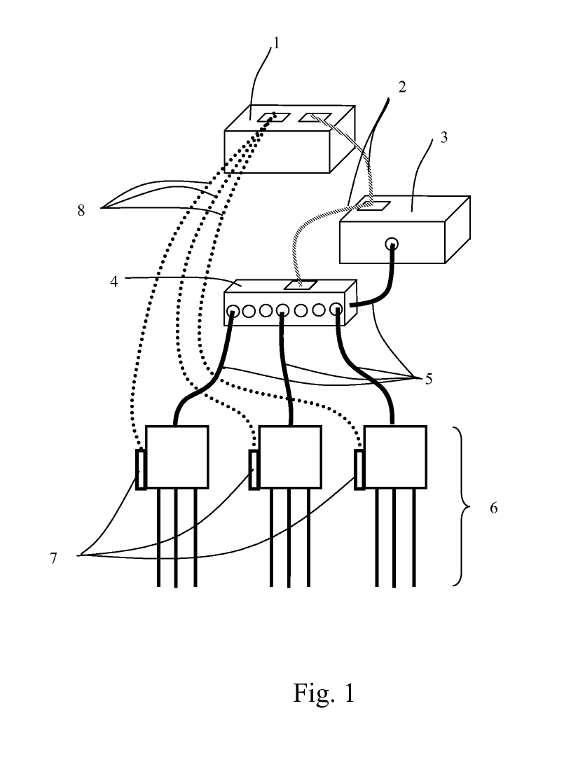

Referring to FIG. 1, the apparatus for SSC measurement according to the present invention comprises TDR sensing waveguides 6, coaxial cables 5, a coaxial multiplexer 4, temperature sensors 7, temperature-sensor cables 8, a time domain reflectometer 3, time-domain-reflectometer control lines 2 and a data acquisition system 1. The TDR sensing waveguides 6 are for being submerged in a suspension, such as a mixture of water and soil, and connected sequentially to the coaxial multiplexer 4 and the time domain reflectometer 3 via the coaxial cables 5. The time domain reflectometer 3 transmits an EM wave, or more particularly an EM pulse, and receives a reflected waveform along each said TDR sensing waveguide 6. The reflected waveform is further analyzed to determine a two-way travel time of the EM wave along said TDR sensing waveguide 6. By switching the coaxial multiplexer 4, the time domain reflectometer 3 can be connected to different ones of the TDR sensing waveguides 6. The temperature sensors 7 are used to sense temperatures around the corresponding TDR sensing waveguides 6 to allow temperature correction in SSC analysis.

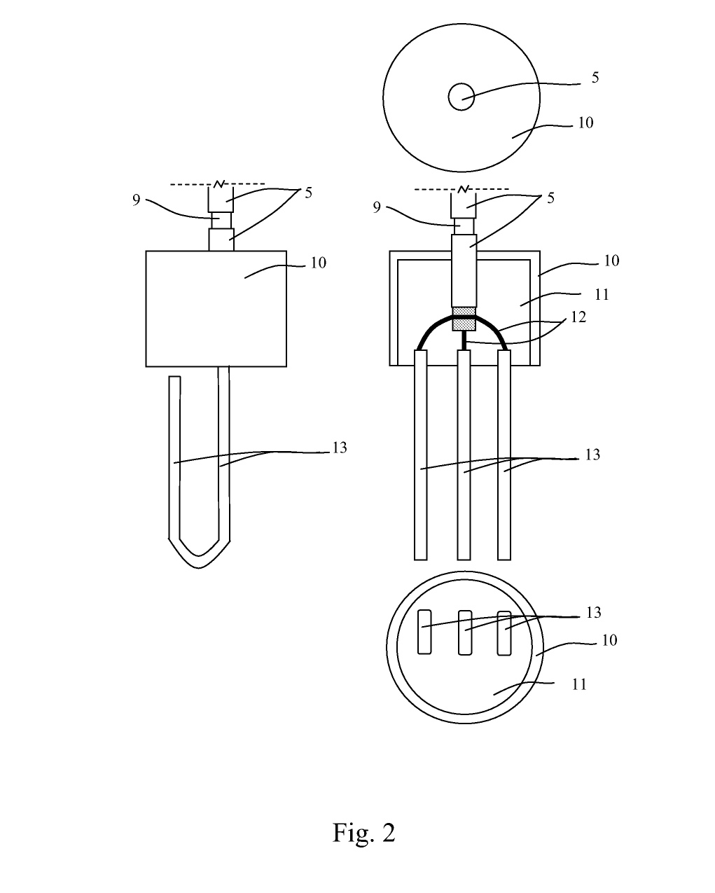

FIG. 2 illustrates the TDR sensing waveguide 6 according to a preferred embodiment of the present invention whose main structure is described now. The inner conductor and the outer conductor of the coaxial cable 5 are connected to probing conductors 13 via inner/outer-conductor connecting lines 12, respectively. The connecting portion between the coaxial cable 5 and the probing conductors 13 is secured by the insulating filling material 11 in the protective metal housing 10 to form a balanced waveguide for sensing and measuring a two-way travel time of an EM wave along the TDR sensing waveguide 6 in the suspension. The protective metal housing 10 serves mainly to shield the electrical field from leaking through, so as to minimize an interference of a leaked electromagnetic field. The probing conductors 13 are arranged in a balanced configuration, such as a coaxial configuration and multi-conductor configuration with three or more parallel conductors, thereby reducing the interference of an antenna effect while increasing the stability of travel-time measurement. If the probing conductors 13 are arranged in an unbalanced configuration consisting of two parallel conductors, a balun transformer is required to connect the coaxial cable with the probing conductors 13. The probing conductors 13 has a distal end boundary capable of forming an open circuit or a short circuit, and can have a geometric shape such as a straight-line shape, a bent shape or a spiral shape, the latter two of which can shorten the TDR sensing waveguide 6 without decreasing the sensing length thereof. The probing conductors 13 can be attached to a columnar or plate-shaped insulating material to form a columnar or plate-shaped TDR sensing waveguide 6. The probing conductors 13 has a length determined by the EM-wave sampling interval and SSC resolution, wherein the greater the length, the higher the resolution. The inner/outer-conductor connecting lines 12 are connected to the probing conductors 13 in a configuration that can minimize discontinuity of transmission-line impedance. When the probing conductors 13 have sufficient lengths, this configuration can reduce an influence of multiple reflections resulting from the inner/outer-conductor connecting lines 12 on travel-time analysis. Moreover, a coaxial-cable impedance discontinuity interface 9 is required to provide a reference signal launch point so as to correct possible drifting of the pulse launch points in the time domain reflectometer 3 itself and difference in EM-wave arrival times at the TDR sensing waveguides 6 due to a difference in temperatures.

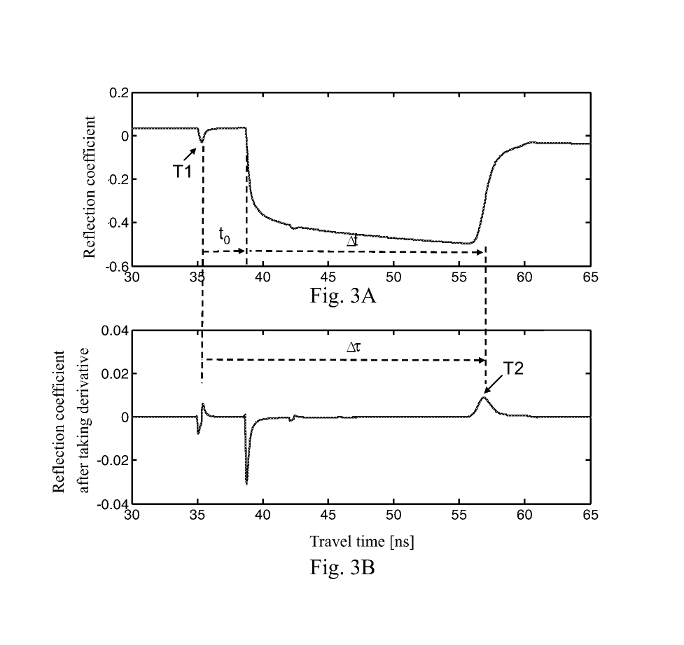

A preferred embodiment of the aforementioned analysis of the two-way travel time of EM waves along the TDR sensing waveguides is shown in FIGS. 3A and 3B. FIG. 3A illustrates a reflected waveform of a water/soil mixture measured with TDR, wherein T1 is a characteristic point of the reflected waveform from the coaxial-cable impedance discontinuity interface 9; T2 is a characteristic point of the reflected waveform from the distal end of the TDR sensing waveguide 6. T2−T1 is defined as TDR travel time Δτ. Δt is the actual sensing travel time of the EM wave along the probing conductors 13, and t₀ is the difference between Δt and Δτ. The TDR reflected waveform is smooth because of the cable resistance, making it difficult to measure Δt directly and stably. Therefore, the characteristic points of the reflected waveform are used in the present invention to allow stable measurement of Δτ, so that the actual sensing travel time Δt=Δτ−t₀ can be stably obtained after t₀ is calibrated. The characteristic point for T1 can be the vertex or other stable characteristic points in the reflected waveform from the coaxial-cable impedance discontinuity interface 9, while the characteristic point for T2 can be the point of inflection of the reflected waveform from the distal end of the TDR sensing waveguide 6, i.e., a vertex of a first derivative of the TDR reflected waveform, as shown in FIG. 3B. As a characteristic point, the point of inflection in the reflected waveform can be automatically analyzed in an easy way and is found not affected by electrical conductivity in water-based suspensions. Furthermore, parameters that control TDR travel times include system parameters of the TDR sensing waveguide (such as the sensing length L of the probing conductors and the difference to between TDR travel time and the actual sensing travel time), respective values of dielectric permittivity of a liquid and suspended solids in a suspension, and SSC. If a TDR travel time is used to determine SSC, it is necessary to calibrate the system parameters of the TDR sensing waveguide and the respective values of dielectric permittivity of the liquid and the suspended solids in the suspension.

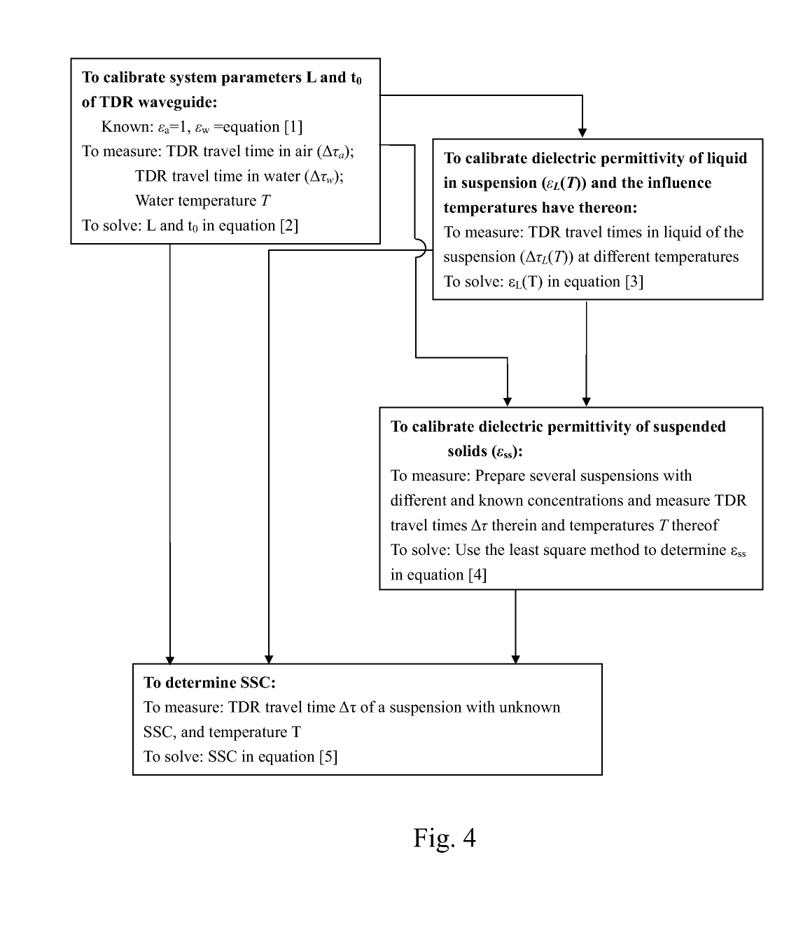

The aforementioned predetermined temperature-corrected relationship between TDR travel time and SSC is explained below while a preferred embodiment of the method for determining SSC is depicted in FIG. 4 as having the following steps:

1. To Calibrate the System Parameters L and t₀ of the TDR Sensing Waveguide

Water and air are accessible and have known values of dielectric permittivity. The dielectric permittivity of air (εₐ) is a constant of 1 and the dielectric permittivity of water (ε_{w}) within the TDR bandwidth can be expressed as:

ε_{w}=78.54·(1−4.58·10⁻³(T−25)·1.19·10⁻⁵(T−25)²−2.5·10⁻⁸(T−25)³) [1]

wherein T (° C.) is temperature. According to the theory of wave propagation and the aforementioned definitions of Δt and Δτ, a TDR travel time in air (Δτₐ) and a TDR travel time in water (Δτ_{w}) can be expressed, respectively, as:

$$\{ \begin{matrix}{Δτ}_{a} = {t}_{0} + \frac{2 L}{c} \sqrt{{ɛ}_{a}} \\ {Δτ}_{w} = {t}_{0} + \frac{2 L}{c} \sqrt{{ɛ}_{w} ( T )}\end{matrix} \qquad [ 2 ]$$

wherein c (2.998×10⁸ m/sec) is the velocity of light. L and t₀ can be solved by measuring TDR travel times along the TDR sensing waveguide in air and in water and the water temperature.
2. To Calibrate the Dielectric Permittivity of a Liquid in a Suspension and the Influence Temperatures have Thereon

If the liquid in the suspension is not the aforementioned water, it is necessary to measure the TDR travel times in the liquid of the suspension (Δτ_{L}) at different temperatures and then calculate the dielectric permittivity of the liquid at different temperatures (ε_{L}) using the following equation:

$$\sqrt{{ɛ}_{L} ( T )} = \frac{c [ {Δτ}_{L} ( T ) - {t}_{0} ]}{2 L} \qquad [ 3 ]$$

### 3. To Calibrate the Dielectric Permittivity of Suspended Solids (ε_{SS})

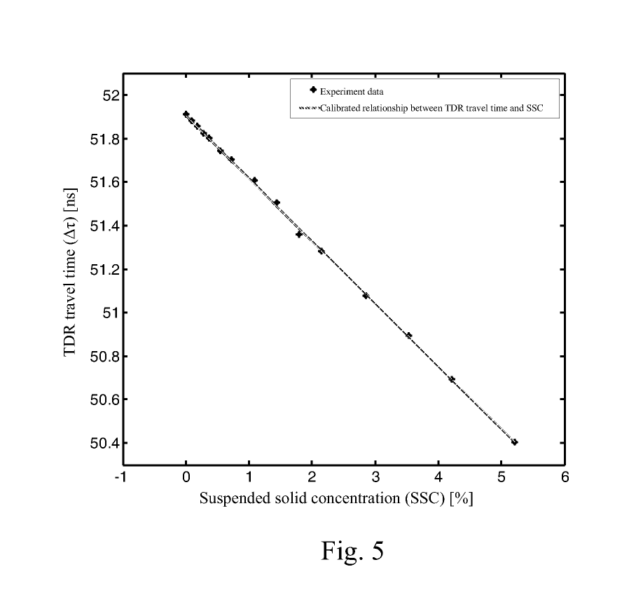

Based on the theory of wave propagation and the aforementioned definitions of Δt and Δτ, a TDR travel time along the TDR sensing waveguide in the suspension can be expressed as:

$$Δτ = {t}_{0} + ( \frac{2 L}{c} ) [ \sqrt{{ɛ}_{L} ( T )} ( 1 - S S C ) + \sqrt{{ɛ}_{ss}} ( S S C ) ] \qquad [ 4 ]$$

wherein Δτ is the TDR travel time along the TDR sensing waveguide in the suspension and SSC is a suspended solid concentration (expressed by volume ratio of the suspended solids in the suspension). In order to calibrate ε_{SS}, several suspensions with different and known concentrations are prepared, and TDR travel times Δτ therein and corresponding temperatures T are measured. ε_{SS} is then calibrated using equation [4] and the least square method. Taking one certain clay for example, a calibration result of SSC versus TDR travel time Δτ is shown in FIG. 5, wherein a good linear relationship is found between TDR travel time Δτ and SSC. This linear relationship is found independent of particle sizes of suspended solids.

### 4. To Determine SSC

Once the system parameters L and t₀ and the respective values of dielectric permittivity of the liquid and suspended solids (ε_{L} and ε_{SS}) are known after calibration, the TDR sensing waveguide and a temperature sensor are used to measure the TDR travel time Δτ in a suspension with an unknown SSC and the temperature (T), respectively. The SSC can be determined by the equation:

$$S S C = \frac{( Δτ - {t}_{0} ) - \frac{2 L}{c} \sqrt{{ɛ}_{L} ( T )}}{\frac{2 L}{c} ( \sqrt{{ɛ}_{ss}} - \sqrt{{ɛ}_{L} ( T )} )} \qquad [ 5 ]$$

Now that values of dielectric permittivity of suspended solids vary only in a limited range, the dielectric permittivity of a certain type of suspended solids can be assumed to be known after calibration is performed on an example of the type. Calibration for dielectric permittivity of a liquid and of the suspended solids of the suspension needs to be conducted only once for the same type of suspensions. When a TDR sensing waveguide having different system parameters is used, the system parameters L and t₀ can be easily calibrated using water and air before measuring.

In equation [5], the system parameters of the TDR sensing waveguide (L and t₀), the dielectric permittivity of a liquid in a suspension and the dielectric permittivity of suspended solids in the suspension can be further integrated into a TDR travel time in the liquid of the suspension (Δτ_{L}) and a TDR travel time in the suspended solids (Δτ_{SS}). Thus, equation [5] is simplified into the following equation:

$$S S C = \frac{Δτ - {Δτ}_{L} ( T )}{{Δτ}_{ss} - {Δτ}_{L} ( T )} \qquad [ 6 ]$$

wherein Δτ_{L} is the TDR travel time in the liquid of the suspension and Δτ_{SS} is the TDR travel time when the medium consists entirely of the suspended solids. When equation [6] is used to estimate SSC, it is necessary to first measure the TDR travel times in the liquid of the suspension at different temperatures (Δτ_{L}(T)), then prepare several suspensions with different and known SSC values and measure the TDR travel times Δτ therein along with temperatures T of said different suspensions. Following that, Δτ_{SS} can be calibrated using equation [6] and the least square method. Once Δτ_{L}(T) and Δτ_{SS} are calibrated, equation [6] can be used to determine SSC. In the simplified method, the system parameters of the TDR sensing waveguide, the dielectric permittivity of the liquid in a suspension and the dielectric permittivity of the suspended solids in the suspension are integrated into Δτ_{L}(T) and Δτ_{SS}. Therefore, when the system parameters of the TDR sensing waveguide are different, Δτ_{L}(T) and Δτ_{SS} must be re-calibrated for accurate measurement.

While the present invention has been described with preferred embodiments thereof, the embodiments are intended for illustrative purposes only and not intended to limit the scope of the present invention. In addition, it is understood that the content disclosed herein can be readily understood and carried out by a person skilled in the art. Therefore, all equivalent changes and modifications which do not depart from the spirit of the present invention should be encompassed by the appended claims.

What is claimed is:

1. A concentration measuring apparatus for measuring a suspended solid concentration of a suspension using time domain reflectometry (TDR) principle, wherein the concentration measuring apparatus measures a two-way travel time (hereinafter referred to as “the TDR travel time”) of an electromagnetic wave in the suspension along with a temperature of the suspension, so as to determine the suspended solid concentration, and the concentration measuring apparatus comprises:
a TDR sensing waveguide for detecting the TDR travel time in the suspension;
a temperature sensor for detecting a temperature of the suspension in order to perform a temperature compensation;
a time domain reflectometer connected to the TDR sensing waveguide for transmitting an electromagnetic pulse and receiving a reflected waveform along the TDR sensing waveguide in order to determine the TDR travel time in the suspension; and
a data acquisition system connected to the time domain reflectometer and the temperature sensor for receiving data of a temperature from the temperature sensor and data of a TDR reflected waveform from the time domain reflectometer in order to determine the suspended solid concentration.

2. The concentration measuring apparatus as claimed in claim 1, wherein the TDR sensing waveguide further comprises:
a coaxial cable;
a set of probing conductors; and
a probe adapter connecting the coaxial cable with the probing conductors.

3. The concentration measuring apparatus as claimed in claim 2, wherein the coaxial cable further comprises an impedance discontinuity interface.

4. The concentration measuring apparatus as claimed in claim 2, wherein the probing conductors have a balanced configuration comprising coaxial conductors or parallel conductors with three or more conductors.

5. The concentration measuring apparatus as claimed in claim 2, wherein the probing conductors have an unbalanced configuration comprising two parallel conductors.

6. The concentration measuring apparatus as claimed in claim 2, wherein the probing conductors are attached to a columnar or plate-shaped insulating material to form a columnar or plate-shaped structure.

7. The concentration measuring apparatus as claimed in claim 5, wherein the coaxial cable and the probing conductors are connected by a balun transformer disposed therebetween.

8. The concentration measuring apparatus as claimed in claim 2, wherein the probing conductors have a distal end boundary capable of forming an open circuit or a short circuit.

9. The concentration measuring apparatus as claimed in claim 2, wherein the probing conductors have a straight-line shape, a spiral shape or a bent shape.

10. The concentration measuring apparatus as claimed in claim 2, wherein the probe adapter has a housing made of a metal or other electrically conductive materials.

11. The concentration measuring apparatus as claimed in claim 2, wherein the probe adapter has an inner filling material which is not electrically conductive.

12. The concentration measuring apparatus as claimed in claim 1, further comprising a coaxial multiplexer for connecting a plurality of said TDR sensing waveguides to the same time domain reflectometer.

13. A method for measuring a suspended solid concentration of a suspension by using the principle of time domain reflectometry to measure a reflected waveform with a concentration measuring apparatus which comprises a TDR sensing waveguide, a temperature sensor, a time domain reflectometer connected to the TDR sensing waveguide, and a data acquisition system connected to the time domain reflectometer and the temperature sensor, wherein the TDR sensing waveguide comprises a set of probing conductors, a coaxial cable, and a probe adapter connecting the coaxial cable with the probing conductors, and the method comprises steps of:
submerging the probing conductors in the suspension;
using the temperature sensor to measure a temperature of the suspension;
analyzing the reflected waveform to determine a TDR travel time; and
using a predetermined temperature-corrected relationship between the TDR travel time and the suspended solid concentration to determine the suspended solid concentration of the suspension, and the step of determining the TDR travel time further comprises steps of:
identifying a first part of the reflected waveform from the impedance discontinuity interface of the coaxial cable and using a vertex or other stable characteristic points in the first part of the reflected waveform as a temporal reference point of an electromagnetic wave travel time;
identifying a second part of the reflected waveform from the distal end of the TDR sensing waveguide and using a vertex or other stable characteristic points in a derivative of the second part of the reflected waveform to define an arrival time of an electromagnetic wave travel time; and
calculating a time difference between the arrival time and the temporal reference point as the TDR travel time.

14. The method as claimed in claim 13, wherein a fixed time difference exists between the TDR travel time and an actual sensing travel time of the electromagnetic wave along the probing conductors of the TDR sensing waveguide in the suspension, in which the fixed time difference and a length of the probing conductors can be used as system parameters of the TDR sensing waveguide and be calibrated by measuring the TDR travel times in two substances having known values of dielectric permittivity or electromagnetic-wave velocity.

15. The method as claimed in claim 13, wherein the predetermined temperature-corrected relationship between the TDR travel time and the suspended solid concentration can be calibrated by steps comprising:
measuring the TDR travel times in two substances (such as air and water) having known values of dielectric permittivity or electromagnetic-wave velocity so as to calibrate the system parameters of the TDR sensing waveguide;
measuring the TDR travel times in a liquid of the suspension at different temperatures and using the measured TDR travel times together with the calibrated system parameters to calibrate a dielectric permittivity of the liquid of the suspension and an influence the temperatures have thereon; and
measuring the TDR travel times in suspensions having different and known suspended solid concentrations along with temperatures of said different suspensions, and using the measured TDR travel times and the measured temperatures together with the calibrated system parameters and the calibrated dielectric permittivity of the liquid of the suspension to calibrate the dielectric permittivity of suspended solids of the suspension, thereby establishing a calibrated relationship among the TDR travel times, the suspended solid concentrations and the temperatures, wherein the calibrated relationship comprises such fixed parameters as the system parameters of the TDR sensing waveguide, the dielectric permittivity of the liquid of the suspension and the dielectric permittivity of the suspended solids of the suspension.

16. The method as claimed in claim 15, wherein the TDR travel time can be converted into a velocity or a dielectric permittivity according to the calibrated system parameters of the TDR sensing waveguide.

17. The method as claimed in claim 15, wherein the dielectric permittivity of the liquid of the suspension and the dielectric permittivity of the suspended solids of the suspension only have to be calibrated once for a same type of suspensions, and wherein only the system parameters of the TDR sensing waveguide have to be calibrated before the concentration measuring apparatus is used for measuring.

18. The method as claimed in claim 15, wherein the steps for calibrating the system parameters of the TDR sensing waveguide, the dielectric permittivity of the liquid of the suspension, and the dielectric permittivity of the suspended solids of the suspension are simplified and integrated into calibrating a TDR travel time in the liquid of the suspension and a TDR travel time in the suspended solids of the suspension, which is carried out by steps comprising:
measuring the TDR travel times in the liquid of the suspension at different temperatures and thereby establishing a relationship between the TDR travel times in the liquid of the suspension and the temperatures thereof; and
measuring the TDR travel times in suspensions having different and known suspended solid concentrations along with temperatures of said different suspensions, calibrating the TDR travel times in suspended solids of said different suspensions, and thereby establishing a calibrated relationship among the TDR travel times, the suspended solid concentrations and the temperatures, wherein the calibrated relationship comprises fixed parameters of the TDR travel time in the liquid of the suspension and the TDR travel time in the suspended solids of the suspension.
